(19) United States
(12) Patent Application Publication
(10) Pub. No.: US 2026/0011812 A1
(43) Pub. Date: Jan. 8, 2026

(54) INTELLIGENT THERMAL BARRIER AND METHOD

(71) Applicant: Aspen Aerogels, Inc., Northborough, MA (US)

(72) Inventors: Brian Cahill, Northborough, MA (US); Christopher Stow, Northborough, MA (US); Lixin Wang, Northborough, MA (US)

(21) Appl. No.: 19/128,881

(22) PCT Filed: Oct. 31, 2023
(86) PCT No.: PCT/US2023/036519

§ 371 Date: May 9, 2025

Related U.S. Application Data
(60) Provisional application No. 63/426,644, filed on Nov. 18, 2022.

(51) Int. Cl. H01M 10/653; G08B 21/18; H01M 10/613; H01M 10/6555; H01M 10/658; H01M 50/293; H01M 50/298

(52) U.S. Cl. CPC H01M 10/653; G08B 21/185; H01M 10/613; H01M 10/6555; H01M 10/658; H01M 50/293; H01M 50/298

(57) ABSTRACT

Various aspects disclosed relate to a battery' module with an intelligent thermal barrier. The present disclosure includes a battery module including a stack of battery cells. a thermal barrier between at least two cells in the stack of battery-cells, and a module cover and housing enclosing the stack of battery cells. The thermal barrier can include at least an isolation layer comprising an aerogel. and at least one sensor.

### CLAIM OF PRIORITY

This application claims the benefit of priority to U.S. Patent Application Ser. No. 63/426,644, filed on Nov. 18, 2022, which is incorporated by reference herein in its entirety.

### TECHNICAL FIELD

The present disclosure relates generally to materials and systems and methods for preventing or mitigating thermal events, such as thermal runaway issues, in energy storage systems. In particular, the present disclosure provides thermal barrier materials. The present disclosure further relates to a battery module or pack with one or more battery cells that includes the thermal barrier materials, as well as systems including those battery modules or packs. Aspects described generally may include aerogel materials.

### BACKGROUND

Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged (being charged beyond the designed voltage), over-discharged, operated at or exposed to high temperature and high pressure.

To prevent cascading thermal runaway events from occurring, there is a need for effective insulation and heat dissipation strategies to address these and other technical challenges of LIBs.

### SUMMARY OF THE DISCLOSURE

In some aspects, a battery module includes a stack of battery cells located within a module housing, a thermal barrier between at least two cells in the stack of battery cells, at least one sensor, and a module cover enclosing the stack of battery cells within the module housing. The thermal barrier can include at least an isolation layer, such as an aerogel layer.

In some aspects, a thermal barrier for use in a battery module can include an isolation layer comprising an aerogel, the isolation layer configured to thermally isolate individual battery cells within the battery module and a pressure sensor at least partially within the thermal barrier.

In some aspects, a battery module can include a stack of battery cells and a battery management system. The stack of battery cells locate within a module housing with a thermal barrier between at least two cells in the stack of battery cells. The thermal barrier can include at least an isolation layer and a sensor embedded in the thermal barrier. The battery management system comprises a controller configured to interface with the sensor embedded in the thermal barrier. The controller can include a processor and a memory including instructions which, when executed cause the processor to receive a signal from the sensor, interpret the signal from the sensor to determine whether a predetermined condition is met, and presenting the alert if the predetermined condition is met based on the interpreted sensor signal.

A method of monitoring a battery module can include receiving a signal from a sensor embedded in a thermal barrier situated between at least two cells of a battery module, interpreting the signal from the sensor to determine whether a predetermined condition is met and presenting the alert if the predetermined condition is met based on the interpreted sensor signal.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of aspect, but not by way of limitation, various aspects discussed in the present document.

FIGS. 1A-1C illustrate a battery module in an aspect.

FIGS. 2A-2C illustrate a thermal barrier with a pressure sensor in an aspect.

FIG. 3 illustrates a thermal barrier with a wireless pressure sensor in an aspect.

FIG. 4 illustrates a thermal barrier with a pressure sensor and a temperature sensor in an aspect.

FIGS. 5A-5B illustrate a thermal barrier with sensors and a conductive layer in an aspect.

FIG. 6 illustrates a thermal barrier with a sheet sensor in an aspect.

FIGS. 7A-7B illustrate a thermal barrier with a sheet sensor having a moisture and gas sensor in an aspect.

FIG. 8 illustrates a thermal barrier with a sensor sheet in an aspect.

FIG. 9 illustrates a battery stack with thermal barriers and embedded sensors in an aspect.

FIG. 10 illustrates a battery stack with thermal barriers and embedded sensors in an aspect.

FIG. 11 illustrates a battery module with a battery stack including thermal barrier with embedded sensors in an aspect.

FIG. 12 illustrates a battery module management system in an aspect.

FIG. 13 illustrates a method of using a thermal runaway warning system in an aspect.

FIG. 14 illustrates a method of using a thermal runaway warning system in an aspect.

FIG. 15 is a block diagram of a typical, general-purpose controller that may be programmed into a special purpose controller suitable for implementing one or more aspects of the thermal runaway warning system herein.

### DETAILED DESCRIPTION

The following description and the drawings sufficiently illustrate specific aspects to enable those skilled in the art to practice them. Other aspects may incorporate structural, logical, electrical, process, and other changes. Portions and features of some aspects may be included in, or substituted for, those of other aspects. Aspects set forth in the claims encompass all available equivalents of those claims.

The present disclosure describes, among other things, systems and methods related to thermal barriers for battery modules. The thermal barriers can be aerogel-based thermal barriers, such as for within or around battery modules. The thermal barrier can be an intelligent thermal barrier including one or more sensors within the thermal barrier to monitor the barrier and surrounding cells in the module. The sensors can include, in one aspect, pressure and temperature sensors.

Thermal barriers, which can include thermally insulative layers and structures, can be used in battery modules to help regulate temperature and heat flow within such battery modules. In one aspect, lithium-ion batteries, often used in a stack of many battery cells, can benefit from thermal regulation to prevent thermal runaway, which could cause potential fires, overheating, combustion, or other issues associated with high temperatures in such a battery module. Often, it is desirable for these battery cells to be monitored. In one aspect, the temperature and pressure of these battery cells can be monitored to determine whether an undesirable event may be imminent. Similarly, the moisture and gas on or around these battery cells can be monitored to help ascertain the healthy level of the battery cells.

Such information can be obtained, in one aspect, by the systems and methods discussed herein that refer to intelligent thermal barriers containing one or more sensors. The intelligent thermal barriers protect the one or more sensors contained therein from heat, particle bombardments, mechanical damages, moisture, or other damages in undesired conditions, such as thermal runaway. Positioning the one or more sensors at least partially within the intelligent thermal barrier also preserves space in the battery module housing to for a more efficient module design.

Such thermal barriers can be made of thermal isolation materials as discussed in detail below. Isolation materials can be used as a single heat resistant layer, or in combination with other layers that provide additional function to a multilayer configuration, such as mechanical strength, compressibility, heat dissipation/conduction, etc. Isolation layers described herein are responsible for reliably containing and controlling heat flow from heat-generating parts in small spaces and to provide safety and prevention of fire propagation for such products in the fields of electronic, industrial, and automotive technologies.

In many aspects of the present disclosure, the isolation layer functions as a flame/fire deflector layer either by itself or in combination with other materials that enhance performance of containing and controlling heat flow. In one aspect, the isolation layer may itself be resistant to flame and/or hot gases and further include entrained particulate materials that modify or enhance heat containment and control.

One aspect of a highly effective isolation layer includes an aerogel. Aerogels describe a class of material based upon their structure, namely low density, open cell structures, large surface areas (often 900 m²/g or higher) and sub nanometer scale pore sizes. The pores may be filled with gases such as air Aerogels can be distinguished from other porous materials by their physical and structural properties. Although an aerogel material is an exemplary isolation material, the invention is not so limited. Other thermal isolation material layers may also be used in aspects of the present disclosure.

Selected aspects of aerogel formation and properties are described. In several aspects, a precursor material is gelled to form a network of pores that are filled with solvent. The solvent is then extracted, leaving behind a porous matrix. A variety of different aerogel compositions are known, and they may be inorganic, organic, and inorganic/organic hybrid. Inorganic aerogels are generally based upon metal alkoxides and include materials such as silica, zirconia, alumina, and other oxides. Organic aerogels include, but are not limited to, urethane aerogels, resorcinol formaldehyde aerogels, and polyimide aerogels.

Inorganic aerogels may be formed from metal oxide or metal alkoxide materials. The metal oxide or metal alkoxide materials may be based on oxides or alkoxides of any metal that can form oxides. Such metals include, but are not limited to silicon, aluminum, titanium, zirconium, hafnium, yttrium, vanadium, cerium, and the like. Inorganic silica aerogels are traditionally made via the hydrolysis and condensation of silica-based alkoxides (such as tetraethoxylsilane), or via gelation of silicic acid or water glass. Other relevant inorganic precursor materials for silica based aerogel synthesis include, but are not limited to metal silicates such as sodium silicate or potassium silicate, alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, polyethylsilicates, partially hydrolyzed polyethysilicates, monomeric alkylalkoxy silanes, bis-trialkoxy alkyl or aryl silanes, polyhedral silsesquioxanes, or combinations thereof.

In certain aspects of the present disclosure, pre-hydrolyzed TEOS, such as Silbond H-5 (SBH5, Silbond Corp), which is hydrolyzed with a water/silica ratio of about 1.9-2, may be used as commercially available or may be further hydrolyzed prior to incorporation into the gelling process. Partially hydrolyzed TEOS or TMOS, such as polyethysilicate (Silbond 40) or polymethylsilicate may also be used as commercially available or may be further hydrolyzed prior to incorporation into the gelling process.

Inorganic aerogels can also include gel precursors comprising at least one hydrophobic group, such as alkyl metal alkoxides, cycloalkyl metal alkoxides, and aryl metal alkoxides, which can impart or improve certain properties in the gel such as stability and hydrophobicity. Inorganic silica aerogels can specifically include hydrophobic precursors such as alkylsilanes or arylsilanes. Hydrophobic gel precursors may be used as primary precursor materials to form the framework of a gel material. However, hydrophobic gel precursors are more commonly used as co-precursors in combination with simple metal alkoxides in the formation of amalgam aerogels. Hydrophobic inorganic precursor materials for silica based aerogel synthesis include, but are not limited to trimethyl methoxysilane (TMS), dimethyl dimethoxysilane (DMS), methyl trimethoxysilane (MTMS), trimethyl ethoxysilane, dimethyl diethoxysilane (DMDS), methyl triethoxysilane (MTES), ethyl triethoxysilane (ETES), diethyl diethoxysilane, dimethyl diethoxysilane (DMDES), ethyl triethoxysilane, propyl trimethoxysilane, propyl triethoxysilane, phenyl trimethoxysilane, phenyl triethoxysilane (PhTES), hexamethyldisilazane and hexaethyldisilazane, and the like. Any derivatives of any of the above precursors may be used and specifically certain polymeric of other chemical groups may be added or cross-linked to one or more of the above precursors.

Organic aerogels are generally formed from carbon-based polymeric precursors. Such polymeric materials include, but are not limited to resorcinol formaldehydes (RF), polyimide, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one aspect, organic RF aerogels are typically made from the sol-gel polymerization of resorcinol or melamine with formaldehyde under alkaline conditions.

Organic/inorganic hybrid aerogels are mainly comprised of (organically modified silica (“ormosil”) aerogels. These ormosil materials include organic components that are covalently bonded to a silica network. Ormosils are typically formed through the hydrolysis and condensation of organically modified silanes, R—Si(OX)₃, with traditional alkoxide precursors, Y(OX)₄. In these formulas, X may represent, in one aspect, CH₃, C₂H₅, C₃H₇, C₄H₉; Y may represent, in one aspect, Si, Ti, Zr, or Al; and R may be any organic fragment such as methyl, ethyl, propyl, butyl, isopropyl, methacrylate, acrylate, vinyl, epoxide, and the like. The organic components in ormosil aerogel may also be dispersed throughout or chemically bonded to the silica network.

Aerogels can be formed from flexible gel precursors. Various flexible layers, including flexible fiber-reinforced aerogels, can be readily combined, and shaped to give pre-forms that when mechanically compressed along one or more axes, give compressively strong bodies along any of those axes.

One method of aerogel formation includes batch casting. Batch casting includes catalyzing one entire volume of sol to induce gelation simultaneously throughout that volume. Gel-forming techniques include adjusting the pH and/or temperature of a dilute metal oxide sol to a point where gelation occurs. Suitable materials for forming inorganic aerogels include oxides of most of the metals that can form oxides, such as silicon, aluminum, titanium, zirconium, hafnium, yttrium, vanadium, and the like. Particularly preferred are gels formed primarily from alcohol solutions of hydrolyzed silicate esters due to their ready availability and low cost (alcogel). Organic aerogels can also be made from melamine formaldehydes, resorcinol formaldehydes, and the like.

In one aspect, aerogel materials may be monolithic, or continuous throughout a structure or layer. In other aspects, an aerogel material may include a composite aerogel material with aerogel particles that are mixed with a binder. Other additives may be included in a composite aerogel material, including, but not limited to, surfactants that aid in dispersion of aerogel particles within a binder. A composite aerogel slurry may be applied to a supporting plate such as a mesh, felt, web, etc. and then dried to form a composite aerogel structure.

As noted above, an aerogel may be organic, inorganic, or a mixture thereof. In some aspects, the aerogel includes a silica-based aerogel. One or more layers in a thermal barrier may include a reinforcement material. The reinforcing material may be any material that provides resilience, conformability, or structural stability to the aerogel material. Aspects of reinforcing materials include, but are not limited to, open-cell macroporous framework reinforcement materials, closed-cell macroporous framework reinforcement materials, open-cell membranes, honeycomb reinforcement materials, polymeric reinforcement materials, and fiber reinforcement materials such as discrete fibers, woven materials, non-woven materials, needled non-wovens, battings, webs, mats, and felts.

The reinforcement material can be selected from organic polymer-based fibers, inorganic fibers, carbon-based fibers, or a combination thereof. The inorganic fibers are selected from glass fibers, rock fibers, metal fibers, boron fibers, ceramic fibers, basalt fibers, or combination thereof. In some aspects, the reinforcement material can include a reinforcement including a plurality of layers of material.

Fiber reinforcement materials can comprise a range of materials, including, but not limited to: Polyesters, polyolefin terephthalates, poly(ethylene)naphthalate, polycarbonates (examples Rayon, Nylon), cotton, (e.g. lycra manufactured by DuPont), carbon (e.g. graphite), polyacrylonitriles (PAN), oxidized PAN, pre-oxidized PAN, uncarbonized heat treated PANs (such as those manufactured by SGL carbon), glass or fiberglass based material (like S-glass, 901 glass, 902 glass, 475 glass, E-glass) silica based fibers like quartz, (e.g. Quartzel manufactured by Saint-Gobain), Q-felt (manufactured by Johns Manville), Saffil (manufactured by Saffil), Durablanket (manufactured by Unifrax) and other silica fibers, Duraback (manufactured by Carborundum), Polyaramid fibers like Kevlar, Nomex, Sontera (all manufactured by DuPont), Conex (manufactured by Taijin), polyolefins like Tyvek (manufactured by DuPont), Dyneema (manufactured by DSM), Spectra (manufactured by Honeywell), other polypropylene fibers like Typar, Xavan (both manufactured by DuPont), fluoropolymers like PTFE with trade names as Teflon (manufactured by DuPont), Goretex (manufactured by W.L. GORE), Silicon carbide fibers like Nicalon (manufactured by COI Ceramics), ceramic fibers like Nextel (manufactured by 3M), Acrylic polymers, fibers of wool, silk, hemp, leather, suede, PBO-Zylon fibers (manufactured by Tyobo), Liquid crystal material like Vectan (manufactured by Hoechst), Cambrelle fiber (manufactured by DuPont), Polyurethanes, polyamaides, Wood fibers, Boron, Aluminum, Iron, Stainless Steel fibers and other thermoplastics like PEEK, PES, PEI, PEK, PPS.

The glass or fiberglass-based fiber reinforcement materials may be manufactured using one or more techniques. In certain aspects, it is desirable to make them using a carding and cross-lapping or air-laid process. In exemplary aspects, carded and cross-lapped glass or fiberglass-based fiber reinforcement materials provide certain advantages over air-laid materials. In one aspect, carded and cross-lapped glass or fiberglass-based fiber reinforcement materials can provide a consistent material thickness for a given basis weight of reinforcement material. In certain additional aspects, it is desirable to further needle the fiber reinforcement materials with a need to interlace the fibers in z-direction for enhanced mechanical and other properties in the final aerogel composition.

In addition to thermal insulating layers, thermally conductive layers in combination with thermal insulating layers are effective at channeling unwanted heat to a desired external location, such as external heat dissipating fins, a heat dissipating housing, or other external structure to dissipate unwanted heat to outside ambient air. In one aspect, a thermally conductive layer or layers helps to dissipate heat away from a localized heat load within a battery module or pack. Aspects of high thermal conductivity materials include carbon fiber, graphite, silicon carbide, metals including but not limited to copper, stainless steel, aluminum, and the like, as well as combinations thereof.

To aid in the distribution and removal of heat, in at least one aspect the thermally conductive layer is coupled to a heat sink. It will be appreciated that there are a variety of heat sink types and configurations, as well as different techniques for coupling the heat sink to the thermally conductive layer, and that the present disclosure is not limited to the use of any one type of heat sink/coupling technique. In one aspect, at least one thermally conductive layer of the multilayer materials disclosed herein can be in thermal communication with an element of a cooling system of a battery module or pack, such as a cooling plate or cooling channel of the cooling system. For another aspect, at least one thermally conductive layer of the multilayer materials disclosed herein can be in thermal communication with other elements of the battery pack, battery module, or battery system that can function as a heat sink, such as the walls of the pack, module, or system, or with other ones of the multilayer materials disposed between battery cells. Thermal communication between the thermally conductive layer of the multilayer materials and heat sink elements within the battery system can allow for removal of excess heat from the cell or cells adjacent to the multilayer material to the heat sink, thereby reducing the effect, severity, or propagation of a thermal event that may generate excess heat.

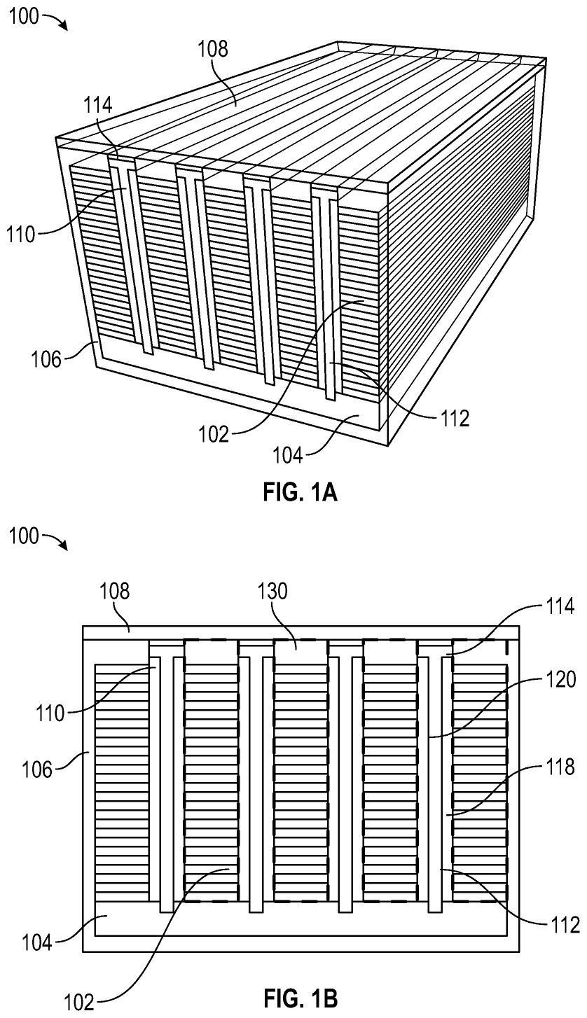

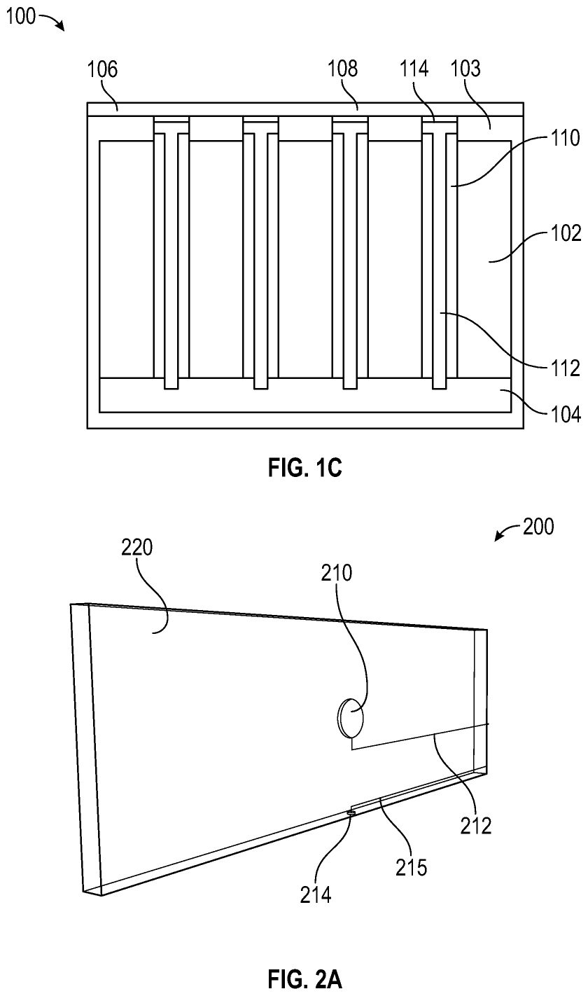

FIGS. 1A-1C illustrate a battery module 100 in an aspect. FIG. 1A shows one aspect of a battery module 100. The module 100 includes a stack of battery cells 102. The battery cells 102 may be selected from different cell formats, such as prismatic, cylindrical, pouch, other cell formats, or combinations thereof. The battery cells 102 may be selected from different cell chemistries, such as lithium ion, sodium ion, other alkaline ion, nickel manganese cobalt battery, lithium-ion phosphate battery, anode-less battery, semi-solid state battery, solid state battery, other battery chemistries, or combinations thereof. In one aspect, the stack of cells 102 includes lithium-ion cells 102. Several configurations of lithium-ion cells 102 are possible. In one aspect, the stack of lithium-ion cells 102 includes lithium-ion pouch cells, although the invention is not so limited. A heat sink 104 is shown located on a side of the module 100, and in thermal communication with the battery cells 102. In the aspect of FIG. 1A, the stack of battery cells 102 are located within a module housing 106. A module cover 108 is further shown enclosing the stack of battery cells 102 within the module housing 106.

Thermal barriers 110 are shown between at least two cells in the stack of battery cells 102. In the aspect of FIG. 1A, a thermal barrier 110 is included between each two cells in the stack of battery cells 102, although the invention is not so limited. In one aspect, groups of cells 102 are separated by thermal barriers 110. Inclusion of thermal barriers 110 provides a level of increased safety in the event of a thermal runaway in one or more of the cells 102. If a thermal runaway event occurs, a region affected by destruction of a failed cell 102 is contained to a region between thermal barriers 110 and/or the module housing 106. Improved thermal barriers 110 are desired to better isolate and protect adjacent regions within a battery module 100 in the event of thermal runaway in one or more individual cells 102.

A heat sink 104 is shown in FIG. 1A. Aspects of heat sinks 104 include, but are not limited to, passive heat sinks such as metal plates, and active heat sinks such as fluid recirculation systems that remove beat to a remote location. In the aspect of FIG. 1A, thermal barriers 110 interlock with the heat sink within a slot or other recess. In one aspect, the heat sink 104 is a separate component contained within the module housing 106. In one aspect, the heat sink 104 is integral with a bottom surface of the module housing 106.

FIG. 1B shows a cross section view of the battery module 100 from FIG. 1A. A thermal barrier 110 is shown including a structural support plate 112. The thermal barrier 110 also includes a module cover contact 114 located on a top end of the structural support plate 112. A thermal isolation layer 118 is shown coupled to one side of the structural support plate 112. In the aspect of FIG. 1B, a second thermal isolation layer 120 is shown coupled to an opposite side of the structural support plate 112 from the thermal isolation layer 118.

As shown in FIG. 1B, at least some of the cells 102 are separated by thermal barriers 110. A space 130 is shown above the cells 102 within the module housing 106 and the module cover 108. In the event of a thermal runaway, gasses may vent into the space 130 above a cell 102. In one aspect cells 102 include a vent (not shown) that specifically directs gasses into the space 130. In such an event, it is desirable to contain the hot gasses, and keep them from affecting adjacent cells 102.

FIG. 1C shows another aspect of portions of a battery module 100. In the aspect of FIG. 1C, a number of cells 102 are shown. In the aspect, a heat sink can be included. A number of thermal barriers 110 are shown selectively separating one or more cells 102 within the stack of cells. One or more thermal isolation layers are shown coupled to the heat sink 104.

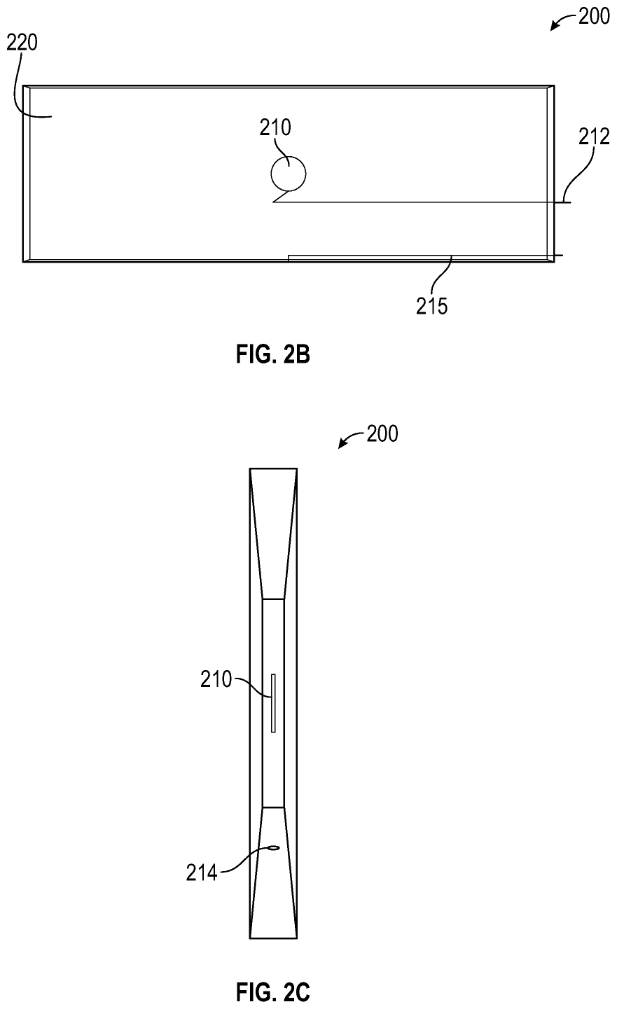

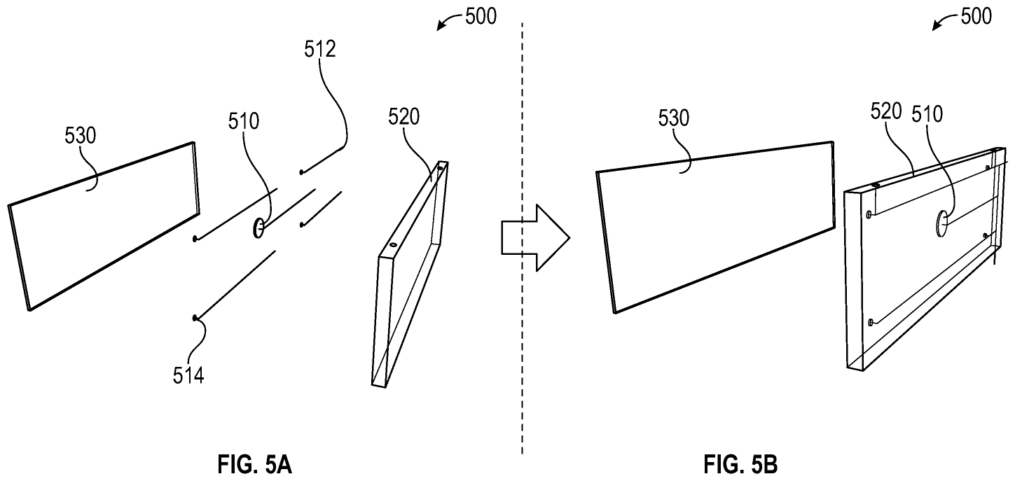

The battery module 100 of FIGS. 1A, 1B, and 1C, can in one aspect, include thermal barriers with one or more sensor integrated into the thermal barriers. Such sensors can include, in one aspect, pressure, temperature, gas, moisture, or other sensors. These sensors can be integrated into the thermal barriers in various configurations, as described below with reference to FIGS. 2A to 8.

FIGS. 2A-2C illustrate a thermal barrier 200 with a pressure sensor 210 in an aspect. The thermal barrier 200 can be used, in one aspect, in a battery module such as those described herein. The thermal barrier 200 can be used between cells in such a battery module for thermal regulation, such as to prevent thermal runaway. The thermal barrier 200 is an intelligent thermal barrier, such that it includes one or more sensors that help in the monitoring and/or control of the battery module in which the thermal barrier 200 resides. In some cases, multiples of the thermal barrier 200 can be used within a battery module.

The thermal barrier 200 can include an isolation layer 220 and the pressure sensor 210. Additionally, the thermal barrier 200 can include a signal cable 212, and a temperature sensor 214 with a signal cable 215.

The thermal barrier 200 can be a layer or material inside a battery module between or adjacent battery cells or groups. The thermal barrier 200 can be made of an aerogel material, such as described above. The thermal barrier 200 can include an isolation layer 220 made of the aerogel material to thermally isolate adjacent battery cells or groups.

The pressure sensor 210 can be a sensor configured to sense pressure of gases or liquids within the battery module and the thermal barrier 200. The pressure sensor 210 can also sense the compression pressure of the isolation layer 220 caused by the volume changes of the adjacent battery cells. The compression pressure is an indicator of the battery cell health and an indicator of the onset of a thermal runaway event. In one aspect, the pressure sensor 210 can be used to monitor pressure within the aerogel of the isolation layer 220, or of a space between the isolation layer 220 and other components of the battery module in which the thermal barrier 200 resides. The pressure sensor 210 can be, in one aspect, an absolute pressure sensor, a gauge pressure sensor, a vacuum pressure sensor, a differential pressure sensor, or a sealed pressure sensor.

In some cases, the pressure sensor 210 can be adjacent the isolation layer 220, such as next to the aerogel, as shown in FIGS. 2A and 2B. In some cases, the pressure sensor 210 can be fully or partially embedded in the isolation layer 220, such as in the aerogel, as shown in FIG. 2C. In some cases, where the pressure sensor 210 is partially embedded in the isolation layer 220, a surface of the pressure sensor 210 can be in proximity of a battery cell in the module so as to monitor pressure near or on the surface of the battery cell.

The pressure sensor 210 in the thermal barrier 200 can be wired, such as with signal cable 212. In some cases, multiple signal cables can be used to electrically couple the pressure sensor 210 to controller circuitry, e.g., a battery management system (BMS) circuitry. The signal cable 212 can transmit pressure signals and transmit power to the pressure sensor 210. The signal cable 212 can be embedded in the isolation layer 220. The signal cable 212 can be, in one aspect, one or more wires. The isolation layer 220 protects the signal cable 212 from heat or mechanical damages during normal operation of the battery module or during a extreme event such as thermal runaway.

In some cases, the thermal barrier 200 can include a structural component coupled to the aerogel in the isolation layer, such as the structural support plate 112 in FIG. 1C. In one aspect, a structural support can be included such as a plate or scaffolding. The pressure sensor 210 can, in some cases, be integrated into or on the structural component.

In some cases, additional or alternative sensors to the pressure sensor 210 can be included in the thermal barrier 200. In other variants, the thermal barrier 200 can include additional or alternative pressure, temperature, moisture, gas sensors or gas pressure sensors. Additional types of sensors are discussed more below.

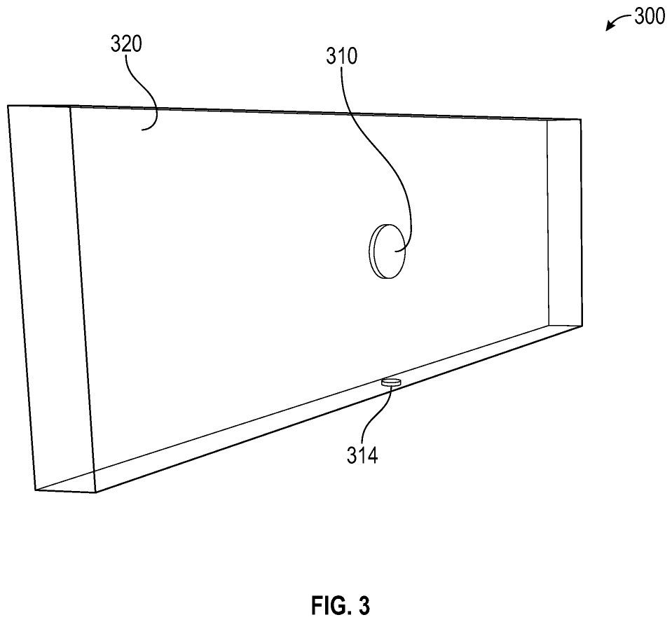

FIG. 3 illustrates a thermal barrier 300 with a wireless pressure sensor 310 in an aspect. In this case, the pressure sensor 310 can be embedded in or placed adjacent the aerogel in the isolation layer 320 without signal cables or wires. In one aspect, the pressure sensor 310 can be a Bluetooth enabled or other type of wireless sensor. In some cases, the thermal barrier 300 can additionally include a temperature sensor 314 that is either wired or wireless. The temperature sensor 314 may be in direct contact with the cooling plate 104 in FIGS. 1A to 1C to detect the temperature of the cooling plate. In some aspects, the temperature sensor 314 is installed in a different surface of the isolation layer 320. In one aspect, the surface to which the pressure sensor 310 attached is perpendicular to the surface to which the temperature sensor 314 is attached.

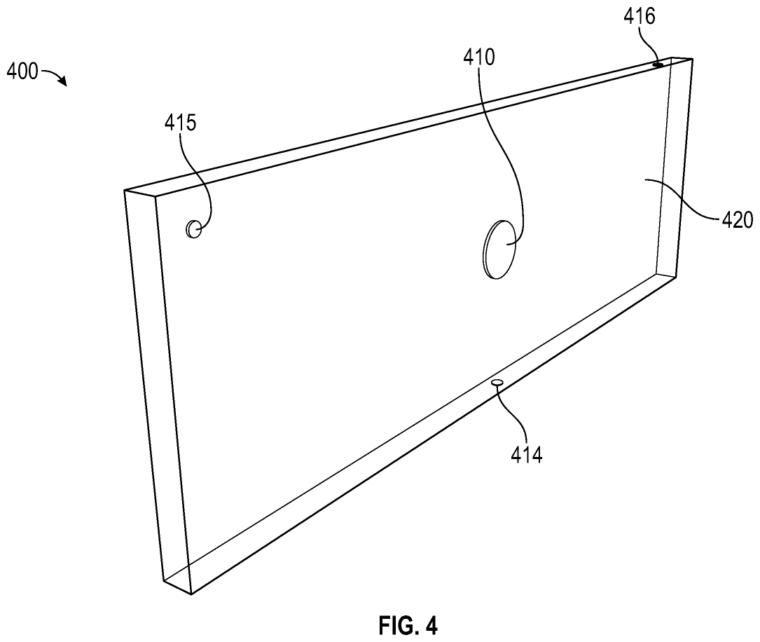

FIG. 4 illustrates a thermal barrier 400 with a pressure sensor 410 and a first temperature sensor 414, a second temperature sensor 415, and a third temperature sensor 416, in an aspect. The temperature sensor 414 can be a temperature sensor on or near the cooling plate in the battery module. The temperature sensor 415 can be a sensor embedded in the thermal barrier 400 for monitoring of the temperature of the aerogel in the isolation layer. The temperature sensor 415 can also be attached to a surface of the thermal barrier 400 facing a battery cell, where the temperature sensor 415 can monitor the temperature of the adjacent battery cell. The temperature sensor 416 may face the space 130 above the cells 102 within the module housing as shown in FIGS. 1A to 1C. The temperature sensor 416 can therefore detect the temperature of the space 130 in the event of thermal runaway.

The temperature sensors 414, 415, 416 can be electrically connected wirelessly or through signal cables. The temperature sensors 414, 415, 416 can be, in one aspect, a thermistor, a thermocouple, a resistance thermometer, a silicon bandgap temperature sensor, or other appropriate temperature sensor or thermometer.

The thermal barrier 400 can include a cooling plate adjacent the isolation layer 420. The cooling plate can be between the thermal barrier 400 and a battery cell to dissipate heat. The temperature sensors 414, 415, 416 can be embedded in or near the isolation layer 420 aerogel, such as near the cooling plate. The temperature sensors 414, 415, 416 can be used to monitor temperature in and around the cooling plate of the thermal barrier 400. The cooling plate may include carbon fiber, graphite, silicon carbide, metals including but not limited to copper, stainless steel, aluminum, and the like, as well as combinations thereof. In one aspect, a thermally conductive layer may include a cooling channel with coolant flow therein.

The thermal barrier 400 can further comprises a structural support plate structured the same way as the cooling plate, except the structural support plate may not be heat conductive. The structural support plate may be selected from mica plate, mica paper, other forms of mica, felt, foamed polymers, solid polymers, composite materials, other materials more rigid than the isolation layer 420, or combinations thereof.

In some cases, the temperature sensors 414, 415, 416 can be embedded in the thermal barrier 400, with a surface exposed to an adjacent battery cell. In some cases, the temperature sensors 414, 415, 416 can be partially embedded in the thermal barrier 400 aerogel so that a surface of the temperature sensors 414, 415, 416 faces or is in contact with one of the stack of lithium-ion battery cells. In some cases, the temperature sensors 414, 415, 416 can be partially embedded in the thermal barrier 400 aerogel so that a surface of the temperature sensor 414 faces away from one of the stack of lithium-ion battery cells. In some cases, the temperature sensors 414, 415, 416 and the pressure sensor 410 can be positioned on one or more surfaces of the isolation layer 420. In one aspect, the temperature sensors 414, 415, 416 and the pressure sensor 410 are positioned on four different surfaces of the isolation layer 420 perpendicular to each other. In one aspect, one or more of the temperature sensors 414, 415, 416 and the pressure sensor 410 are positioned on the surface of the isolation layer 420. Sensors at different locations are used to collect data for the controller to analyze the health conditions of the battery module.

FIGS. SA-5B illustrate a thermal barrier 500 with pressure sensor 510, temperature sensor 514, signal cables 512, isolation layer 520 and a conductive layer 530 in an aspect. Here, the temperature sensor 514, the pressure sensor 510, or both can be embedded in the isolation layer 520 aerogel. In some cases, the sensor(s) can be partially embedded in the isolation layer 520 with a surface facing the conductive layer 530. The conductive layer 530 can be made of thermally conductive materials, such as described above. The signal cables 512 can be embedded in the isolation layer 520 to connect the temperature sensor 514 and/or the pressure sensor 510. The isolation layer 520 protects the pressure sensor 510, the temperature sensor 514, and the signal cables 512 from possible mechanical, corrosion, and heat damage during a thermal runaway event.

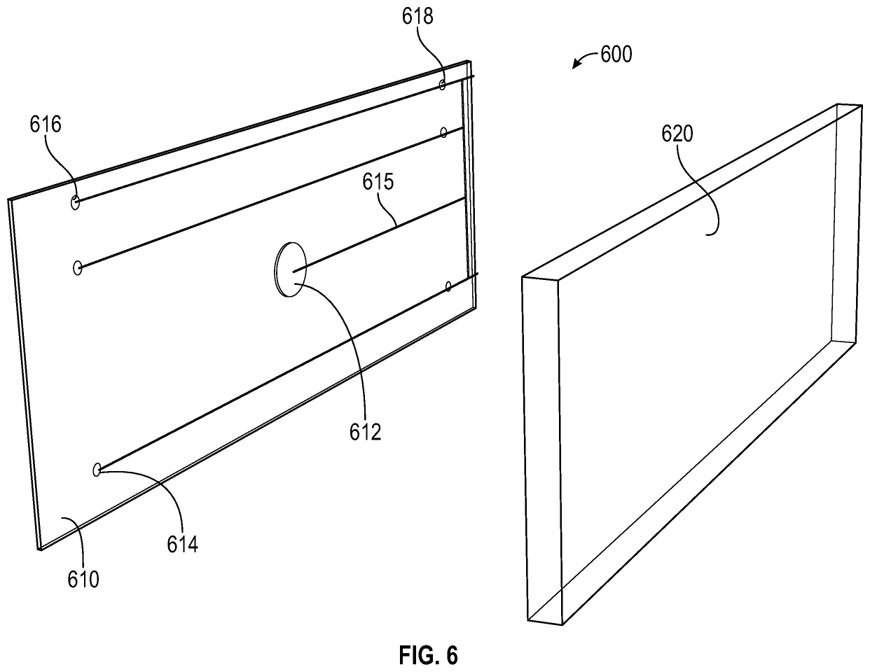

FIG. 6 illustrates a thermal barrier 600 with an isolation layer 620 and a sheet sensor 610 in an aspect. The sheet sensor 610 can include a pressure sensor 612, a temperature sensor 614, a moisture sensor 616, and a gas sensor 618.

The various sensors can be located on and integrated into the sheet sensor 610. The sheet sensor 610 can be sized and shaped for insertion next to the isolation layer 620 within a battery module. The sheet sensor 610 can additionally include a number of channels 615 for wires or cables to electrically connect the various sensors to controller circuitry, such as for providing electricity and transmitting signals from the various sensors.

The moisture sensor 616 and the gas sensor 618 can be, in one aspect, for monitoring moisture and gas within the thermal barrier 600 or between the thermal barrier 600 and one or more lithium-ion battery cells in the battery module. The moisture sensor 616 can be used to monitor for water or other fluids that are present in the battery module. The gas sensor 618 can in one aspect be an oxygen, carbon dioxide, or other type of gas sensor. In some cases, the gas sensor 618 can be an electrochemical sensor, an infrared sensor, an ultrasonic sensor, or other type of gas sensor as appropriate.

One or more of the temperature sensor 614, the pressure sensor 612, the moisture sensor 616, and the gas sensor 618 can be wireless. In some cases, the sensors can be integrated into a single sensor.

The sheet sensor 610 can be a printed circuit board. The sheet sensor 610 can, in some cases, be used as a map. In communication with controller circuitry, the sheet sensor 610 can be used to map temperature, pressure, moisture, gas, or other sensed attributes, across the geography of the sheet sensor 610 and the thermal barrier 600.

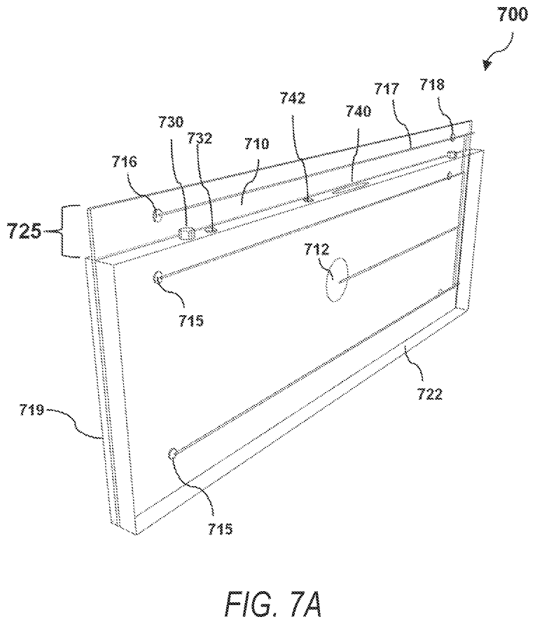

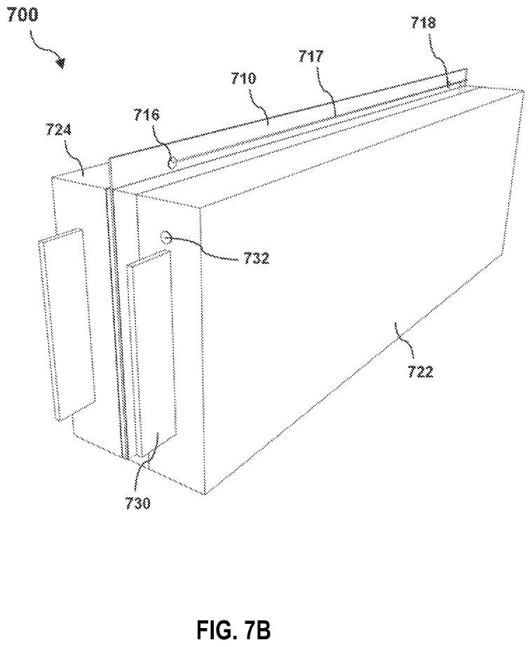

FIGS. 7A-7B illustrate a thermal barrier 700 with a sensor sheet 710 having a pressure sensor 712, a temperature sensor 715, a moisture sensor 716, and a gas sensor 718, connected by channels 717, in an aspect. The sensor sheet 710 can include at least one layer 719, such as an isolation layer, conductive layer, a structural supporting layer, a rigid layer, or a resilient layer, for providing variety of properties to the thermal barrier 700. A portion 725 of the sensor sheet 710 can extend beyond the isolation layer 720 and the adjacent battery cells 722, 724. The moisture sensor 716 and gas sensor 718 can be on the portion 725 such that the moisture sensor 716 and gas sensor 718 are exposed to air in the battery housing and can detect moisture and gas externally of the adjacent battery cells 722, 724. In one aspect, the moisture sensor 716 and gas sensor 718 can be used to detect smoke in the battery housing.

As shown in FIG. 7A, the adjacent battery cells 722, 724 may further include one or more sensors 732, 742 adjacent to the venting hole 730 and/or the electrical terminals 740 of the battery cells 722, 724. The one or more sensors 732, 742 may be on an edge of the battery cells 722, 724 parallel to the length direction of the extension portion 725 as shown in FIG. 7A. Alternatively, the one or more sensors 732, 742 may be on an edge of the battery cells 722, 724 perpendicular to the length direction of the extension portion 725 as shown in FIG. 7B. In one aspect, the adjacent battery cells 722, 724 are prismatic battery cells (e.g., FIG. 7A) or pouch cells (FIG. 7B).

The one or more sensors 732, 742 may be any sensors, such as temperature sensors, pressure sensors, gas pressure sensors, gas sensors, and/or combinations thereof. The one or more sensors 732, 742 may be wired to the sensor sheet 710. Alternatively, the one or more sensors 732, 742 may be wirelessly connected to the sensor sheet 710 or the battery manage system.

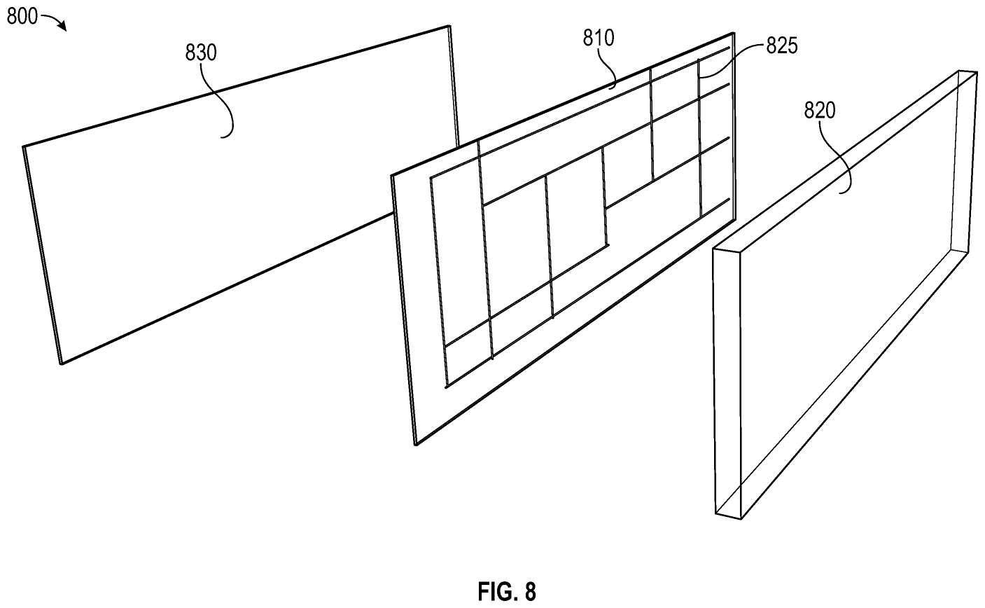

FIG. 8 illustrates an exploded view of a thermal barrier 800 with a sensor sheet 810, an isolation layer 820, and a conductive layer 830 in an aspect. The sensor sheet 810 can include a plurality of sensors and routing 825. The sensor sheet 810 can be, in one aspect, a printed circuit with embedded sensors to create a map for mapping temperature, pressure, moisture, gas, gas composition, or other attributes, within the battery housing.

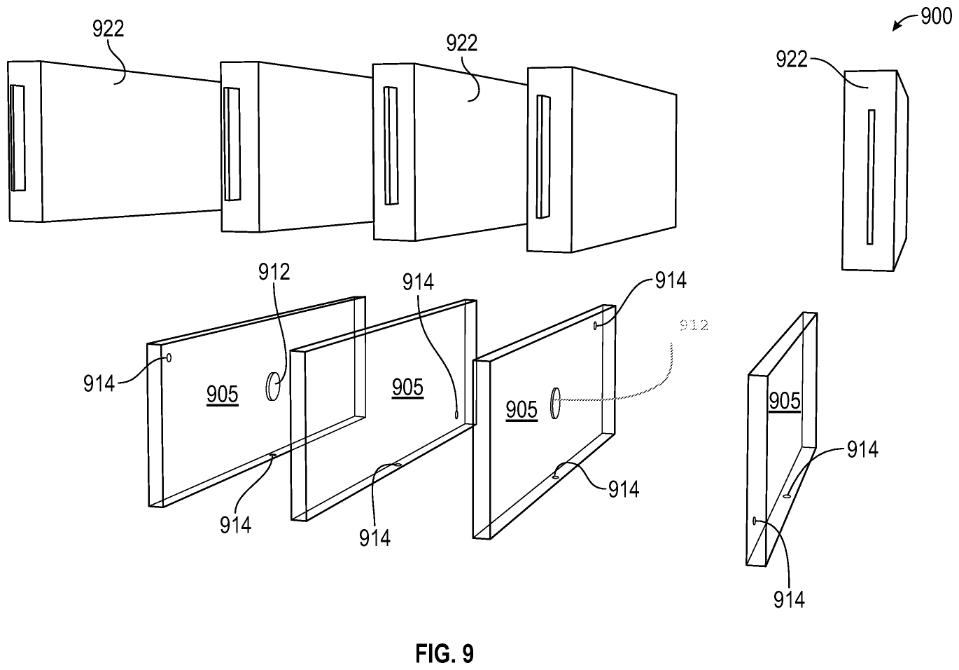

FIG. 9 illustrates an exploded view of a battery stack 900 with thermal barriers 905 and embedded sensors in an aspect. The battery stack 900 can include battery cells 922 and thermal barriers 905. Various sensors, including temperature sensors 914 and pressure sensors 912 in various positions on each of the thermal barriers 905.

In some cases, the various sensors 912, 914, can be central to the thermal barriers 905. In some cases, the various sensors 912, 914, can be at different corners of the thermal barriers 905 in a battery module. In some cases, the various sensors 912, 914, can be situated on different sides of the thermal barriers 905. The thermal barriers 905 are more compressible than the various sensors. The incorporation of the sensors in the thermal barriers 905 decreases the compressibility of the thermal barriers 905, especially at the locations where the sensors are located. The compressibility decrease is more prominent when multiple thermal barriers are used in a battery module aligned together. The locations in the thermal barriers where the sensors are have the least compressibility compared to the locations without sensors. The sensors at different corners (shown in FIG. 9) of the thermal barriers 905 can mitigate the compressibility decreases by distributing the sensors into different corners of the thermal barriers.

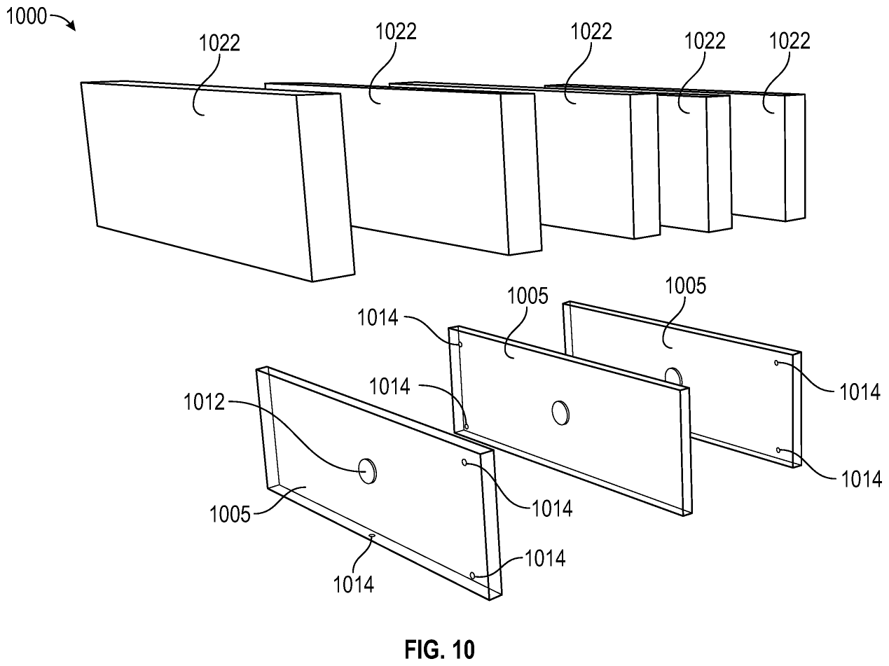

FIG. 10 illustrates an exploded view of a battery stack 1000 with thermal barriers 1005 and embedded sensors 1012, 1014, and battery cells 1022 in an aspect.

In some cases, the various sensors 1012, 1014, can be central to the thermal barriers 1005. In some cases, the various sensors 1012, 1014, can be at different corners of the thermal barriers 1005. In some cases, the various sensors 1012, 1014, can be situated on different edges of the thermal barriers 1005. In one aspect, the sensors 1014 are positioned on the opposite edges of the thermal barriers 1005. Positioning the sensors 1014 on different edges of the adjacent thermal barrier 1005 can provide additional compressibility for the battery stack 1000.

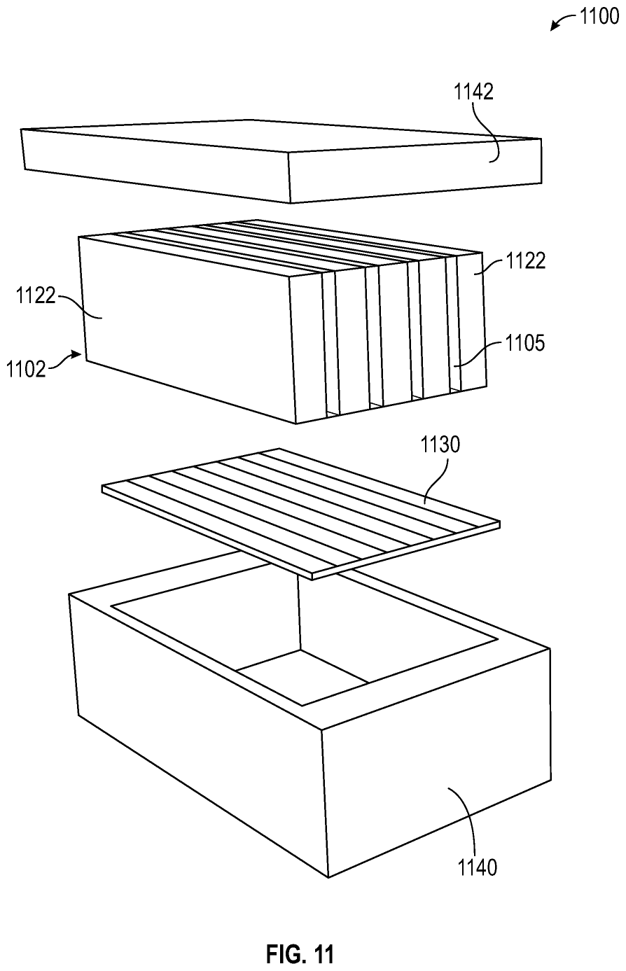

FIG. 11 illustrates a battery module 1100 with a battery stack 1102 including battery cells 1122, thermal barriers 1105 with embedded sensors, cooling plate 1130, housing 1140, and lid 1142, in an aspect.

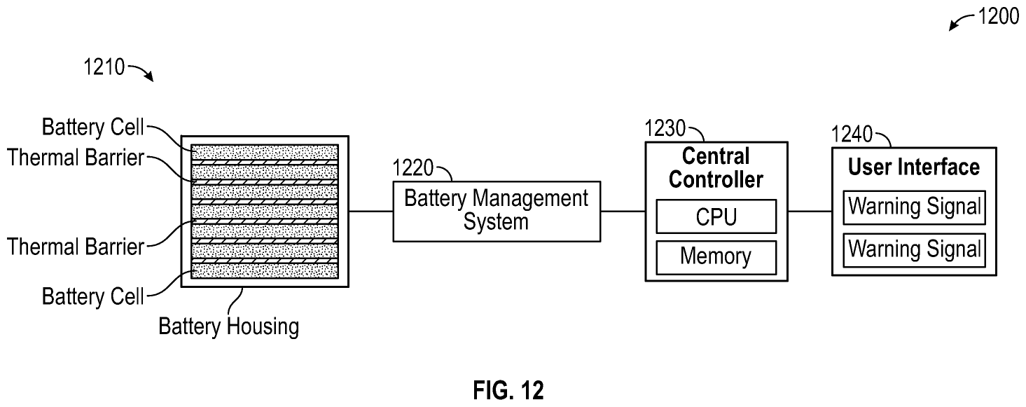

FIG. 12 illustrates a battery module management system 1200 in an aspect. The system can include a battery module 1210, a management system 1220, a controller 1230, and a user interface 1240.

The battery module 1210 can be coupled to the management system 1220, the controller 1230, and the user interface 1240. The sensors in the battery module 1210 can be coupled to the controller 1230 and controller 1230 through one or more wires, or wirelessly, such as to provide sensor readings and signals therebetween.

The management system 1220 can be used to adjust parameters in the battery module 1210 based on sensor signals. The management system 1220 can store historical sensor data and information. The management system 1220 can collect and compute the sensor test data and compare the collected and computed sensor test data to historical sensor data and information. In one aspect, the management system 1220 can compare the collected sensor data to desired ranges or thresholds of sensor data based on historical data or other database information.

The management system 1220 can determine whether the detected sensor data rises to a level of a warning, such as outside a desired range or above a predetermined threshold. Such warnings can be communicated through the controller 1230 to the user interface 1240 to alert the user of the system. The battery module management system 1200 can additionally provide warning signals and feedback to mitigate thermal runaway. This can result in allowing a user to manually adjust the system accordingly, or can help institute, with the controller 1230 automatically execute changes.

In one aspect, the system 1200 can include a battery module comprising a stack of lithium-ion cells located within a module housing, and a thermal barrier between at least two cells in the stack of lithium-ion cells, the thermal barrier including at least an isolation layer and a sensor embedded in the thermal barrier. And a controller configured to interface with the sensor embedded in the thermal barrier.

The controller can include a processor and a memory including instructions which, when executed cause the processor to receive a signal from the sensor, interpret the signal from the sensor to determine whether a predetermined condition is met; and present the alert if the predetermined condition is met based on the interpreted sensor signal.

In some cases, the instructions can cause the processor to automatically execute an action based on the alert. In some cases, interpreting the signal can include comparing the signal to historical data. In some cases, the predetermined condition comprises thermal runaway. In some cases, presenting the alert can include providing a warning to a user on a user interface.

In some cases, the battery module management system 1200 can be used to warn a user of thermal runaway, such as by method 1300 or method 1400 below. In one aspect, if the battery module and system 1200 are in an automobile, a Level I warning can include “emergency, leave the vehicle.” A Level II warning can include “stop driving, immediate maintenance needed.” A Level III warning can include “maintenance”.

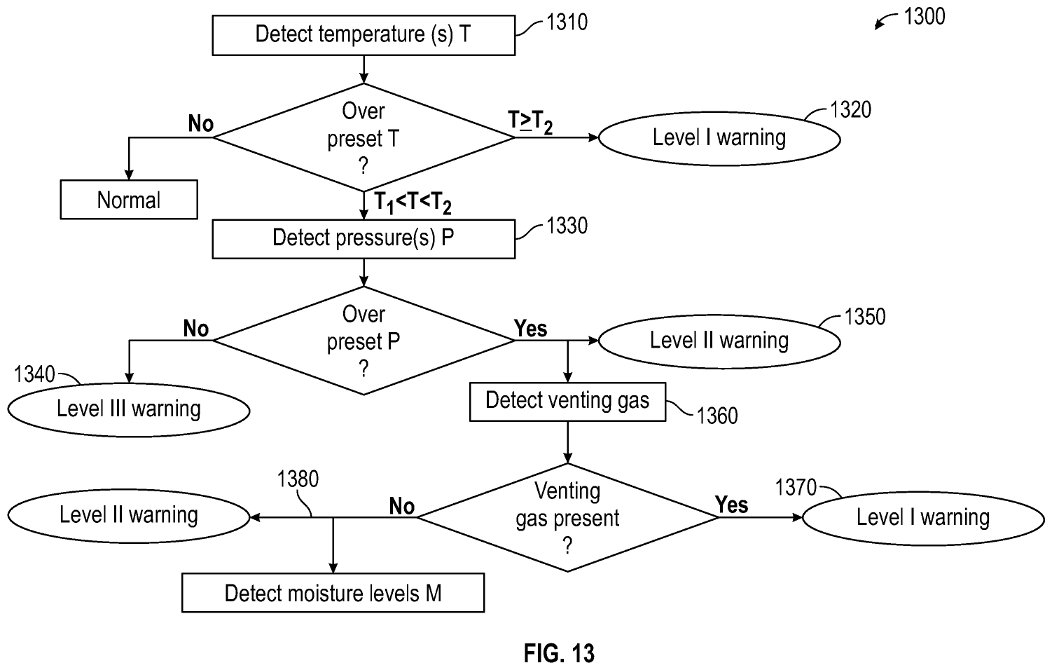

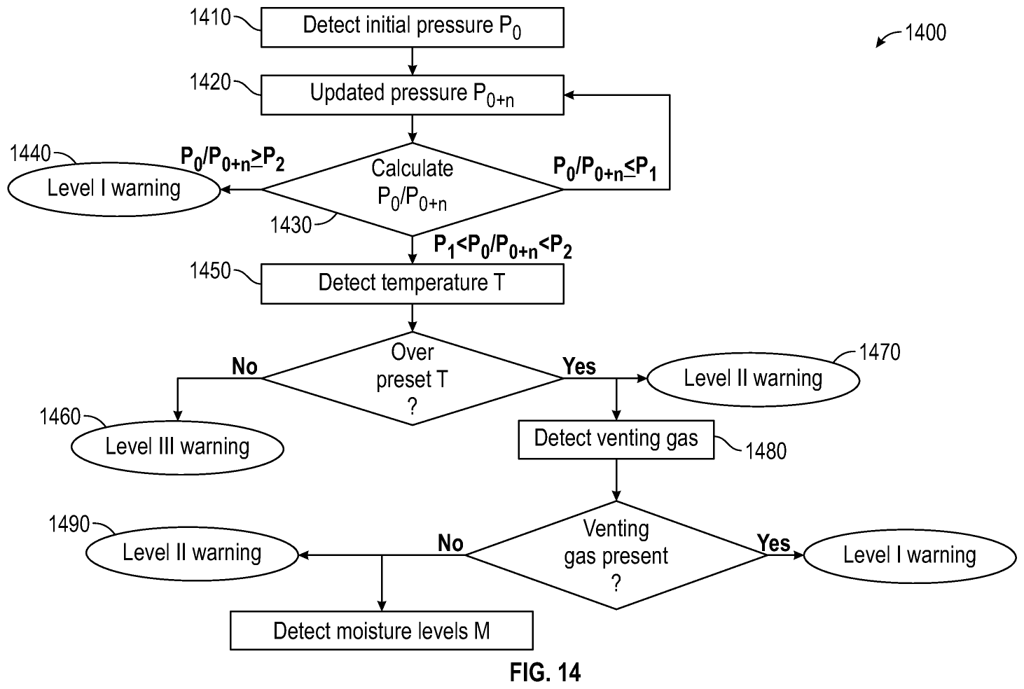

FIG. 13 illustrates a method 1300 of using a thermal runaway warning system in an aspect. FIG. 14 illustrates an alternative method 1400 of using a thermal runaway warning system in an aspect.

The methods can include a method of monitoring a battery module. The method can include receiving a signal from a sensor embedded in a thermal barrier situated between at least two cells of a battery module, interpreting the signal from the sensor to determine whether a predetermined condition is met, and presenting the alert if the predetermined condition is met based on the interpreted sensor signal.

Specifically, the method 1300 can include detecting a temperature (step 1310). The system can determine whether the temperature is over a preset temperature threshold. If the temperature is not over the threshold, no warning is issued. If, however, the temperature is over the threshold, a Level I warning can be issued (step 1320). Alternatively, if the temperature lands in an intermediate range, the pressure can be detected (step 1330) to further diagnose the possible issue. If the pressure is below a preset threshold, a Level III warning can be issued (step 1340). If the pressure is over a preset pressure threshold, a Level II warning can be issued (step 1350). In this case, a gas detector can be used to determine whether gas is venting (step 1360). If gas is venting, a Level I warning can be issued (step 1370). If not, the moisture can be detected. If the moisture is detected over a preset moisture threshold, a level II warning can be issued (step 1380).

Alternatively, the method 1400 can include detecting an initial pressure (step 1410). An updated pressure can then be detected (step 1420). A differential in pressures can be calculated (step 1430). If the calculated differential is over a desired threshold, a Level I warning can be issued (step 1440). If not, temperature can be detected (step 1450). If the temperature is not over a preset threshold, a Level III warning can be issued (step 1460). If the temperature is over a preset threshold, a Level II warning can be issued (step 1470). In this case, a gas sensor can be used to determine whether gas is venting. If so, a Level I warning can be issued (step 1480). If not, moisture can be detected, and a Level II warning can be issued (step 1490). Other aspect methods can be used with various combinations of sensors

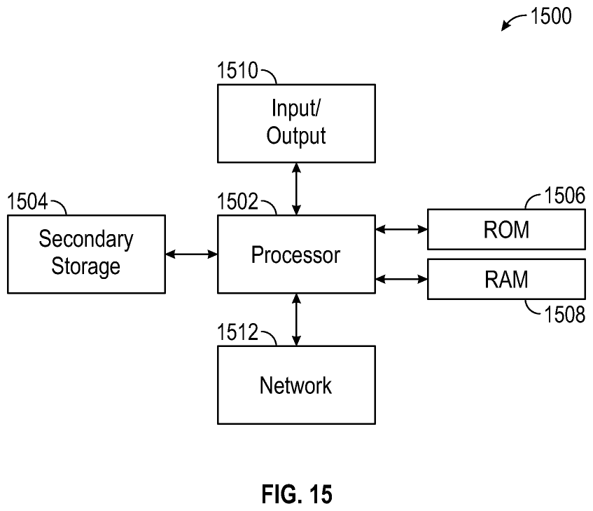

FIG. 15 is a block diagram of a typical, general-purpose computer 1500 that may be programmed into a special purpose computer suitable for implementing one or more aspects disclosed herein. The management system described above may be implemented on any general-purpose processing component, such as a computer with sufficient processing power, memory resources, and communications throughput capability to handle the necessary workload placed upon it. The computer 1500 includes a processor 1502 (which may be referred to as a central processor unit or CPU) that is in communication with memory devices including secondary storage 1504, read only memory (ROM) 1506, random access memory (RAM) 1508, input/output (I/O) devices 1510, and network connectivity devices 1512. The processor 1502 may be implemented as one or more CPU chips or may be part of one or more application specific integrated circuits (ASICs).

The secondary storage 1504 is typically comprised of one or more disk drives or tape drives and is used for non-volatile storage of data and as an over-flow data storage device if RAM 1508 is not large enough to hold all working data. Secondary storage 1504 may be used to store programs that are loaded into RAM 1508 when such programs are selected for execution. The ROM 1506 is used to store instructions and perhaps data that are read during program execution. ROM 1506 is a non-volatile memory device that typically has a small memory capacity relative to the larger memory capacity of secondary storage 1504. The RAM 1508 is used to store volatile data and perhaps to store instructions. Access to both ROM 1506 and RAM 1508 is typically faster than to secondary storage 1504.

The devices described herein may be configured to include computer-readable non-transitory media storing computer readable instructions and one or more processors coupled to the memory, and when executing the computer readable instructions configure the computer 1500 to perform method steps and operations described above. The computer-readable non-transitory media includes all types of computer readable media, including magnetic storage media, optical storage media, flash media and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through physical medium or distribution system, including, in one aspect, from a server owned by the software creator or from a server not owned but used by the software creator. The software may be stored on a server for distribution over the internet, in one aspect.

Also, it will be understood by one skilled in the art that this disclosure is not limited in its application to the details of construction and the arrangement of components set forth in the description or illustrated in the drawings. The aspects herein are capable of other aspects, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled”, and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated aspects may be implemented, at least in part, in digital electronic circuitry, analog electronic circuitry, or in computer hardware, firmware, software, or in combinations of them. These components may be implemented, in one aspect, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. A computing program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative aspects may be performed by one or more programmable processors executing a computing program, code or instructions to perform functions (e g., by operating on input data and/or generating an output). Method steps may also be performed by, and apparatus may be implemented as, special purpose logic circuitry, e.g., an FPGA (field programmable gate array) or an ASIC (application-specific integrated circuit), in one aspect.

The various illustrative logical blocks, modules, and circuits described in connection with the aspects disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of aspect, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of aspect, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. In one aspect, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

### Various Notes & Aspects

Aspect 1 is a battery module comprising: a stack of lithium-ion cells located within a module housing; a thermal barrier between at least two cells in the stack of lithium-ion cells, the thermal barrier including at least an isolation layer comprising an aerogel; and at least one sensor; and a module cover enclosing the stack of lithium-ion cells within the module housing.

In Aspect 2, the subject matter of Aspect 1 optionally includes wherein the at least one sensor comprises a pressure sensor, a temperature sensor, a moisture sensor, a gas sensor, or combinations thereof.

In Aspect 3, the subject matter of any one or more of Aspects 1-2 optionally include wherein the at least one sensor is embedded in the aerogel.

In Aspect 4, the subject matter of any one or more of Aspects 1-3 optionally include wherein the at least one sensor is adjacent the aerogel.

In Aspect 5, the subject matter of any one or more of Aspects 1-4 optionally include wherein the thermal barrier further comprises a structural component coupled to the aerogel in the isolation layer.

In Aspect 6, the subject matter of Aspect 5 optionally includes wherein the at least one sensor is on the structural component.

In Aspect 7, the subject matter of any one or more of Aspects 1-6 optionally include wherein the at least one sensor is a wireless sensor.

In Aspect 8, the subject matter of any one or more of Aspects 1-7 optionally include one or more wires extending from the at least one sensor out of the isolation layer to convey signal to and from the sensor.

In Aspect 9, the subject matter of Aspect 8 optionally includes wherein the one or more wires are embedded in the isolation layer.

In Aspect 10, the subject matter of any one or more of Aspects 1-9 optionally include wherein the at least one sensor is partially embedded within the thermal barrier, the at least one sensor having a surface in contact with one of the stack of lithium-ion cells.

In Aspect 11, the subject matter of any one or more of Aspects 1-10 optionally include wherein the at least one sensor is partially embedded within the thermal barrier, the at least one sensor having a surface facing away from one of the stack of lithium-ion cells.

In Aspect 12, the subject matter of any one or more of Aspects 1-11 optionally include a cooling plate adjacent the isolation layer.

In Aspect 13, the subject matter of Aspect 12 optionally includes wherein the at least one sensor is partially embedded within the thermal barrier, the at least one sensor having a surface in contact with the cooling plate.

In Aspect 14, the subject matter of any one or more of Aspects 1-13 optionally include wherein the thermal barrier further comprises a conductive layer.

In Aspect 15, the subject matter of Aspect 14 optionally includes wherein the at least one sensor is partially embedded within the isolation layer, the at least one sensor having a surface in contact with the conductive layer.

In Aspect 16, the subject matter of any one or more of Aspects 14-15 optionally include wherein the conductive layer comprises a thermally conductive material.

In Aspect 17, the subject matter of any one or more of Aspects 1-16 optionally include wherein the at least one sensor comprises a sensor sheet.

In Aspect 18, the subject matter of Aspect 17 optionally includes wherein sensor sheet comprises power channels connecting to the sensors.

In Aspect 19, the subject matter of any one or more of Aspects 17-18 optionally include wherein the sensor sheet comprises a plurality of sensors, and wherein the sensor sheet is configured to allow mapping of one or more parameters across a surface of the sensor sheet.

In Aspect 20, the subject matter of any one or more of Aspects 17-19 optionally include wherein the sensor sheet comprises at least a portion that extends past the thermal barrier and adjacent lithium-ion cells from the stack.

In Aspect 21, the subject matter of Aspect 20 optionally includes wherein the portion of the sensor sheet comprises one or more moisture sensors, gas sensors, or combinations thereof.

In Aspect 22, the subject matter of any one or more of Aspects 17-21 optionally include wherein the sensor sheet comprises a printed circuit board.

In Aspect 23, the subject matter of any one or more of Aspects 17-22 optionally include wherein the sensor sheet comprises at least one sensor at each corner of the sensor sheet.

In Aspect 24, the subject matter of any one or more of Aspects 17-23 optionally include wherein the sensor sheet comprises at least one sensor on each side of the sensor sheet.

Aspect 25 is a thermal barrier for use in a battery module, the thermal barrier comprising: an isolation layer comprising an aerogel, the isolation layer configured to thermally isolate individual battery cells within the battery module; a pressure sensor at least partially within the thermal barrier.

In Aspect 26, the subject matter of Aspect 25 optionally includes wherein the pressure sensor is embedded in the isolation layer.

In Aspect 27, the subject matter of any one or more of Aspects 25-26 optionally include a cooling plate coupled to the isolation layer, wherein the pressure sensor is at least partially embedded in the isolation layer adjacent the cooling plate.

In Aspect 28, the subject matter of any one or more of Aspects 25-27 optionally include a conductive layer coupled to the isolation layer, wherein the pressure sensor is embedded within the thermal barrier between the conductive layer and the isolation layer.

In Aspect 29, the subject matter of any one or more of Aspects 25-28 optionally include wherein the pressure sensor is wireless.

Aspect 30 is a battery management system comprising: a battery module comprising a stack of lithium-ion cells located within a module housing, and a thermal barrier between at least two cells in the stack of lithium-ion cells, the thermal barrier including at least an isolation layer and a sensor embedded in the thermal barrier; and a controller configured to interface with the sensor embedded in the thermal barrier, the controller including a processor and a memory including instructions which, when executed cause the processor to: receive a signal from the sensor; interpret the signal from the sensor to determine whether a predetermined condition is met; presenting the alert if the predetermined condition is met based on the interpreted sensor signal.

In Aspect 31, the subject matter of Aspect 30 optionally includes wherein the instruction further cause the processor to automatically execute an action based on the alert.

In Aspect 32, the subject matter of any one or more of Aspects 30-31 optionally include wherein interpreting the signal comprises comparing the signal to historical data.

In Aspect 33, the subject matter of any one or more of Aspects 30-32 optionally include wherein the predetermined condition comprises thermal runaway.

In Aspect 34, the subject matter of any one or more of Aspects 30-33 optionally include wherein presenting the alert comprises providing a warning to a user on a user interface.

Aspect 35 is a method of monitoring a battery module, the method comprising: receiving a signal from a sensor embedded in a thermal barrier situated between at least two cells of a battery module; interpreting the signal from the sensor to determine whether a predetermined condition is met; presenting the alert if the predetermined condition is met based on the interpreted sensor signal.

Each of these non-limiting aspects can stand on its own or can be combined in various permutations or combinations with one or more of the other aspects.

The above detailed description includes references to the accompanying drawings, which form a part of the detailed description. The drawings show, by way of illustration, specific aspects in which the invention can be practiced. These aspects are also referred to herein as “aspects.” Such aspects can include elements in addition to those shown or described. However, the present inventors also contemplate aspects in which only those elements shown or described are provided. Moreover, the present inventors also contemplate aspects using any combination or permutation of those elements shown or described (or one or more aspects thereof), either with respect to a particular aspect (or one or more aspects thereof), or with respect to other aspects (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method aspects described herein can be machine or computer-implemented at least in part. Some aspects can include a computer-readable medium or machine-readable medium encoded with instructions operable to configure an electronic device to perform methods as described in the above aspects. An implementation of such methods can include code, such as microcode, assembly language code, a higher-level language code, or the like. Such code can include computer readable instructions for performing various methods. The code may form portions of computer program products. Further, in an aspect, the code can be tangibly stored on one or more volatile, non-transitory, or non-volatile tangible computer-readable media, such as during execution or at other times. Aspects of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. In one aspect, the above-described aspects (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description as aspects or aspects, with each claim standing on its own as a separate aspect, and it is contemplated that such aspects can be combined with each other in various combinations or permutations. The scope of the invention should be determined with reference to the appended claims, along with the full scope of equivalents to which such claims are entitled.

1. A battery module comprising:
a stack of battery cells located within a module housing;
a thermal barrier between at least two cells in the stack of battery cells, the thermal barrier including at least an isolation layer;
at least one sensor;
a cooling plate adjacent the isolation layer wherein the at least one sensor is partially embedded within the thermal barrier, the at least one sensor having a surface in contact with the cooling plate; and
a module cover enclosing the stack of battery cells within the module housing.

2. The battery module of claim 1, wherein the at least one sensor comprises a pressure sensor, a temperature sensor, a moisture sensor, a gas sensor, a gas pressure sensor, or combinations thereof.

3. The battery module of claim 1, wherein the at least one sensor is embedded in the isolation layer.

4. The battery module of claim 1, wherein the at least one sensor is adjacent the isolation layer.

5. The battery module of claim 1, wherein the thermal barrier further comprises a structural component coupled to an aerogel in the isolation layer.

6. The battery module of claim 5, wherein the at least one sensor is on the structural component.

7. The battery module of claim 1, wherein the at least one sensor is a wireless sensor.

8. The battery module of claim 1, further comprising one or more wires extending from the at least one sensor out of the isolation layer to convey signal to and from the sensor.

9. The battery module of claim 8, wherein the one or more wires are embedded in the isolation layer.

10. The battery module of claim 1, wherein the at least one sensor is partially embedded within the thermal barrier, the at least one sensor having a surface in contact with one of the stack of battery cells.

11. The battery module of claim 1, wherein the at least one sensor is partially embedded within the thermal barrier, the at least one sensor having a surface facing away from one of the stack of battery cells.

12-13. (canceled)

14. The battery module of claim 1, wherein the thermal barrier further comprises a conductive layer.

15. The battery module of claim 14, wherein the at least one sensor is partially embedded within the isolation layer, the at least one sensor having a surface in contact with the conductive layer.

16. The battery module of claim 14, wherein the conductive layer comprises a thermally conductive material.

17. The battery module of claim 1, wherein the at least one sensor comprises a sensor sheet.

18. The battery module of claim 17, wherein sensor sheet comprises power channels connecting to the sensors.

19. The battery module of claim 17, wherein the sensor sheet comprises a plurality of sensors, and wherein the sensor sheet is configured to allow mapping of one or more parameters across a surface of the sensor sheet.

20. The battery module of claim 17, wherein the sensor sheet comprises at least a portion that extends past the thermal barrier and adjacent battery cells from the stack.

21. The battery module of claim 20, wherein the portion of the sensor sheet comprises one or more moisture sensors, gas sensors, gas pressure sensor, or combinations thereof.

22. The battery module of claim 17, wherein the sensor sheet comprises a printed circuit board.

23. The battery module of claim 17, wherein the sensor sheet comprises at least one sensor at each corner of the sensor sheet.

24. The battery module of claim 17, wherein the sensor sheet comprises at least one sensor on each side of the sensor sheet.

25. A thermal barrier for use in a battery module, the thermal barrier comprising:
an isolation layer comprising an aerogel, the isolation layer configured to thermally isolate individual battery cells within the battery module;
a pressure sensor at least partially within the thermal barrier; and
a cooling plate coupled to the isolation layer, wherein the pressure sensor is at least partially embedded in the isolation layer adjacent the cooling plate.

26. The thermal barrier of claim 25, wherein the pressure sensor is embedded in the isolation layer.

27. (canceled)

28. The thermal barrier of claim 25, further comprising a conductive layer coupled to the isolation layer, wherein the pressure sensor is embedded within the thermal barrier between the conductive layer and the isolation layer.

29. The thermal barrier of claim 25, wherein the pressure sensor is wireless.

30. A battery management system comprising:
a battery module comprising a stack of battery cells located within a module housing, and a thermal barrier between at least two cells in the stack of battery cells, the thermal barrier including at least an isolation layer and a sensor sheet partially embedded in the thermal barrier, the sensor sheet extending past the thermal barrier and at least one battery cell in the stack
wherein the sensor sheet comprises one or more moisture sensors, gas sensors, gas pressure sensor, or combinations thereof; and
a controller configured to interface with the sensor embedded in the thermal barrier, the controller including a processor and a memory including instructions which, when executed cause the processor to:
receive a signal from the sensor;
interpret the signal from the sensor to determine whether a predetermined condition is met; and
present an alert if the predetermined condition is met based on the interpreted sensor signal.

31. The system of claim 30, wherein the instructions further cause the processor to automatically execute an action based on the alert.

32. The system of claim 30, wherein interpreting the signal comprises comparing the signal to historical data.

33. The system of claim 30, wherein the predetermined condition comprises thermal runaway.

34. The system of claim 30, wherein presenting the alert comprises providing a warning to a user on a user interface.

35. (canceled)
